(19) United States
(12) Patent Application Publication
(10) Pub. No.: US 2014/0164079 A1
(43) Pub. Date: Jun. 12, 2014

(54) SOCIAL INCENTIVES FOR COMMERCE

(71) Applicants: John Tapley, Santa Clara, CA (US); Ryan Melcher, Ben Lomond, CA (US); Krystal Rose Higgins, Sunnyvale, CA (US)

(72) Inventors: John Tapley, Santa Clara, CA (US); Ryan Melcher, Ben Lomond, CA (US); Krystal Rose Higgins, Sunnyvale, CA (US)

(73) Assignee: eBay Inc., San Jose, CA (US)

(21) Appl. No.: 13/706,976

(22) Filed: Dec. 6, 2012

(51) Int. Cl. G06Q 30/02

(52) U.S. Cl. CPC G06Q 30/0214
USPC 705/14.16

(57) ABSTRACT

In an example embodiment, a method of validating an electronic incentive provided to users is provided. An electronic incentive can be distributed to a first user. The electronic incentive provides a first discount amount for an item or service. A first indication that the electronic incentive has been redeemed at a merchant point of sale terminal can later be received. Validation may then occur to ensure that the electronic incentive referred to in the first indication is the electronic incentive distributed to the first user. Then, the first discount amount can be dynamically altered into a second discount amount different than the first discount amount, so that a redemption of the electronic incentive by the first user provides a discount equal to the second discount amount.

### BACKGROUND

Coupons and other related incentives for purchasing goods (i.e., commerce) have largely remained the same for many years. Despite the rise of mobile computing devices such as tablet computers and smartphones and the proliferation of the Internet, the coupon itself has generally remained the same: a manufacturer or retailer distributes the coupon to consumers, with the coupon entitling the recipient to a certain deal, such as a fixed dollar amount (or fraction thereof) off of a purchase, or a fixed percentage off of a purchase. While such coupons can now be distributed electronically, the underlying concepts of the coupon being passed from manufacturer/retailer to consumer, and being for a fixed amount, have not changed.

### BRIEF DESCRIPTION OF DRAWINGS

FIG. 1 is a network diagram depicting a networked or network based system, according to an example embodiment, having various components configured for exchanging data over a network.

FIG. 2 is a network diagram depicting a networked or network based system, according to another example embodiment, having various components configured for exchanging data over a network.

FIG. 3 is a diagram illustrating a system, in accordance with an example embodiment, of multiple tiers of users receiving a coupon.

FIG. 4 is a network diagram depicting a networked or network based system, according to another example embodiment, having various components configured for exchanging data over a network.

FIG. 5 is a diagram depicting an example, in accordance with an example embodiment, of coupon related objects maintained by a coupon server.

FIG. 6 is a diagram illustrating a system, in accordance with an example embodiment, of tracking electronic coupons.

FIG. 7 is an interaction diagram illustrating a method, in accordance with an example embodiment, of validating an electronic incentive provided to users.

FIG. 8 is a flow diagram illustrating a method, in accordance with an example embodiment, of validating an electronic incentive provided to users. At 800, an electronic incentive is distributed to a first user.

FIG. 9 shows a diagrammatic representation of machine in the example form of a computer system within which a set of instructions, for causing the machine to perform any one or more of the methodologies discussed herein, may be executed.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Although the present embodiments have been described with reference to specific example embodiments, it will be evident that various modifications and changes may be made to these embodiments without departing from the broader spirit and scope of the embodiments. Accordingly, the specification and drawings are to be regarded in an illustrative rather than a restrictive sense.

In an example embodiment, a system is provided that allows coupons to be passed from consumer to consumer, rather than merely from manufacturer/retailer to consumer. Furthermore, the value of the coupon can change based upon the passing from one consumer to the next. For example, a consumer that passes a coupon to another consumer may see the value of his or her coupon go up, encouraging the passing of coupons from one consumer to the next.

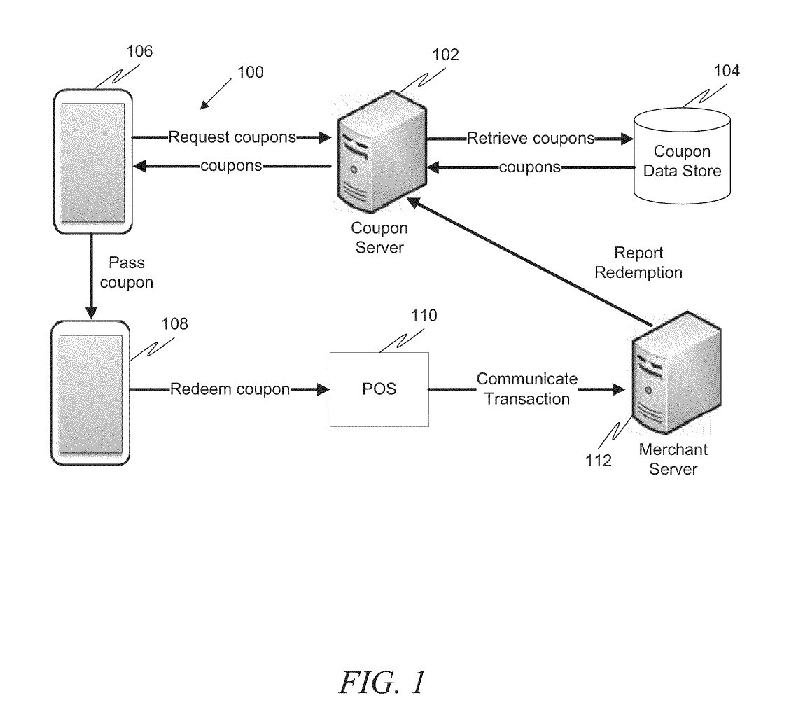

FIG. 1 is a network diagram depicting a networked or network based system, according to an example embodiment, having various components configured for exchanging data over a network. In the system 100, for example, a coupon server 102 may be included to manage the distribution of coupons. Coupons may be stored in a coupon data store 104. A first user device 106 may communicate with the coupon server 102 to obtain lists of available coupons. The coupon server 102 may then access the coupon data store 104 and send notifications of the coupons, along with various other offers and tier levels (e.g., information about how the coupons can change in value depending upon consumer-to-consumer distribution).

It should be noted that while this diagram depicts the coupon server 102 sending coupon information to the first user device 106 in response to a request from the first user device 106, in some example embodiments the coupons are distributed to the first user device via push technology. Push technology is typically (but not necessarily exclusively) implemented using a Hypertext Transfer Protocol (HTTP) server to send data from a web server to a web client, such as via a common gateway interface (CGI).

The first user device 106 at some point passes the coupon to a second user device 108. This passing may be performed via a number of different mechanisms. In one example embodiment, the first user device 106 is in physical proximity to the second user device 108 in order to facilitate the passing of the coupon. This may be accomplished via near field communication (NFC). NFC is a set of standards to establish radio communication between devices by touching the devices together or bringing them within a few centimetres of each other.

In another example embodiment, an application running on the first user device 106 and the second user device 108 may facilitate the passing of the coupon through an application server (not pictured). The application server may be in communication with the first user device 106 and the second user device 108 and may receive location information from the devices (such as via Global Positioning System (GPS) modules on each of the first user device 106 and second user device 108), and may facilitate the transfer of the coupon when the devices are in proximity to each other and a user on the first user device 106 performs a user action (such as a “bumping” motion) that indicates the desire to transfer data to the second user device 108.

In another example embodiment, the first user device 106 sends the coupon via a local wireless networking standard, such as Bluetooth, to the second user device 108.

In another example embodiment, the second user device 108 obtains the coupon by scanning a code, such as a bar code or Quick Response (QR) code, generated and displayed by the first user device 106.

In another example embodiment, the first user device 106 emails the coupon to the second user device 108.

In another example embodiment, the first user device 106 passes the coupon to the second user device 108 via a social networking website post.

When the operator of the second user device 108 wishes to redeem the coupon, he or she may utilize the coupon at a merchant point of sale terminal 110. The coupon can be communicated to the merchant point of sale terminal 110 via electronic or non-electronic means. Examples of electronic means include wireless communication such as NFC, Bluetooth, or WiFi, as well as scanning technologies such as by displaying a bar code or QR code on the second user device 108, which the merchant point of sale terminal 110 can scan. Examples of non-electronic means include the merchant copying down a code displayed on the second user device 108 and entering the code into the merchant point of sale terminal 110, or simply honoring the coupon by providing the appropriate discount at the merchant point of sale terminal 110.

The merchant point of sale terminal 110 may communicate the transaction to a merchant server 112. The merchant server 112 may then report the redemption of the coupon to the coupon server 102. Among other reasons for reporting the redemption, such as for reimbursement from the coupon provider, the merchant server 112 may also be reporting the redemption because the redemption may affect one or more users' redemption values of their own coupons, as will be described in more detail later.

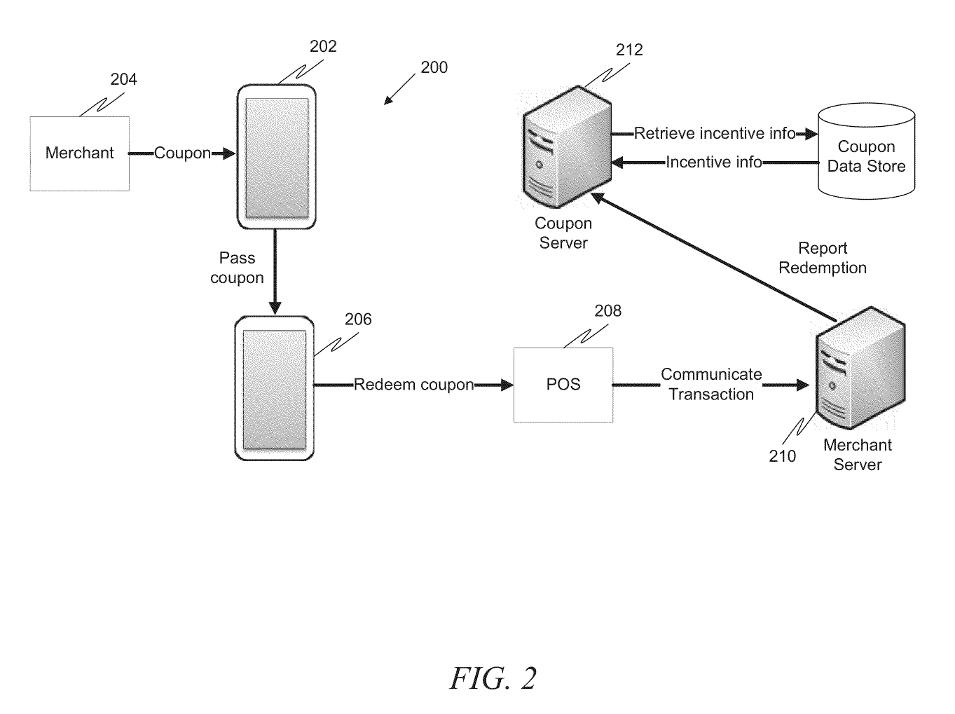

FIG. 2 is a network diagram depicting a networked or network based system, according to another example embodiment, having various components configured for exchanging data over a network. In the system 200, a coupon is obtained by a first user device 202 directly from a merchant 204. This may include, for example, using the first user device 202 to scan a barcode or QR code on a display or tag in a store.

As with FIG. 1, the first user device 202 at some point passes the coupon to a second user device 206. This passing may be performed via a number of different mechanisms, as described above in FIG. 1.

When the operator of the second user device 206 wishes to redeem the coupon, he or she may utilize the coupon at a merchant point of sale terminal 208. The coupon can be communicated to the merchant point of sale terminal 208 via electronic or non-electronic means, as described above with respect to FIG. 1.

The merchant point of sale terminal 208 may communicate the transaction to a merchant server 210. The merchant server 210 may then report the redemption of the coupon to the coupon server 212.

As briefly described above, the redemption value of a coupon, in an example embodiment, can be dynamically changed. In one example embodiment, the value of a coupon to a first user increases when he passes the coupon to another user. In order to reduce potential fraud, in some embodiments, the altering of the value of a coupon does not occur until the recipient of the passing of the coupon redeems the coupon. For example, in the two-user embodiments shown in FIG. 1 and FIG. 2, if the coupon begins as a $1 off coupon, once the second user redeems the coupon, the value of the first user's coupon may rise to, for example, $1.25. The increase in value may be a fixed amount (e.g., $0.25) or may be a percentage (e.g., 25%).

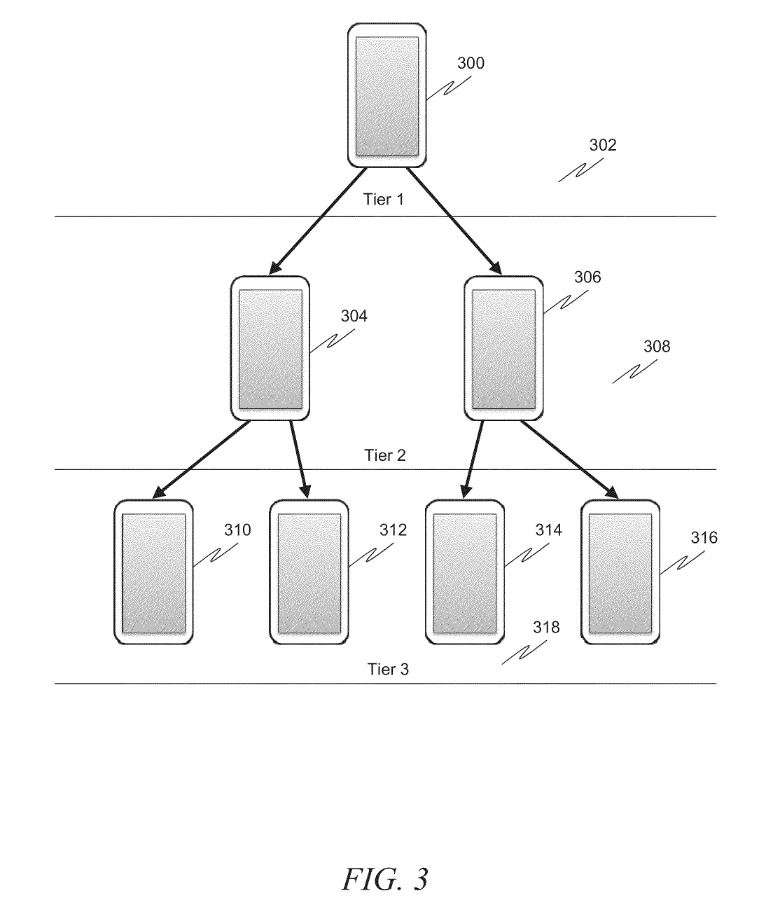

In some example embodiments, the dynamic rise in value of a coupon may continue as more and more tiers of users obtain the coupon. FIG. 3 is a diagram illustrating a system, in accordance with an example embodiment, of multiple tiers of users receiving a coupon. Here, a first user 300 may be in a first tier 302. Anyone to whom the first user 300 directly passes the coupon, such as users 304 and 306, may be in the second tier 308. Anyone to whom one of the users 304, 306 directly passes the coupon, such as users 310, 312, 314, 316, may be in a third tier 318. As users at the lower tiers redeem the coupon, the redemption value of the coupons for users in the higher tiers may increase. Of course, while not depicted, there are an unlimited number of potential tiers, although in some embodiments, the system may place an upper limit on the amount that a user's coupon can increase in value.

It should be noted that the increase in value can either be applied only once per tier, or multiple times per tier. For example, for some coupons, the first user 300 may receive a $0.10 increase in redemption value when one user in the second tier 308 redeems the coupon, and may receive a $0.05 increase in redemption value when one user in the third tier 318 redeems the coupon. However, when, for example, a second user in the second tier 308 redeems the coupon, the first user 300 may not receive an additional increase in redemption value. In other example embodiments, for reach redemption in the second tier 308, the first user may receive an additional increase in redemption. Of course, there still may be limits placed on the number or amounts of increases.

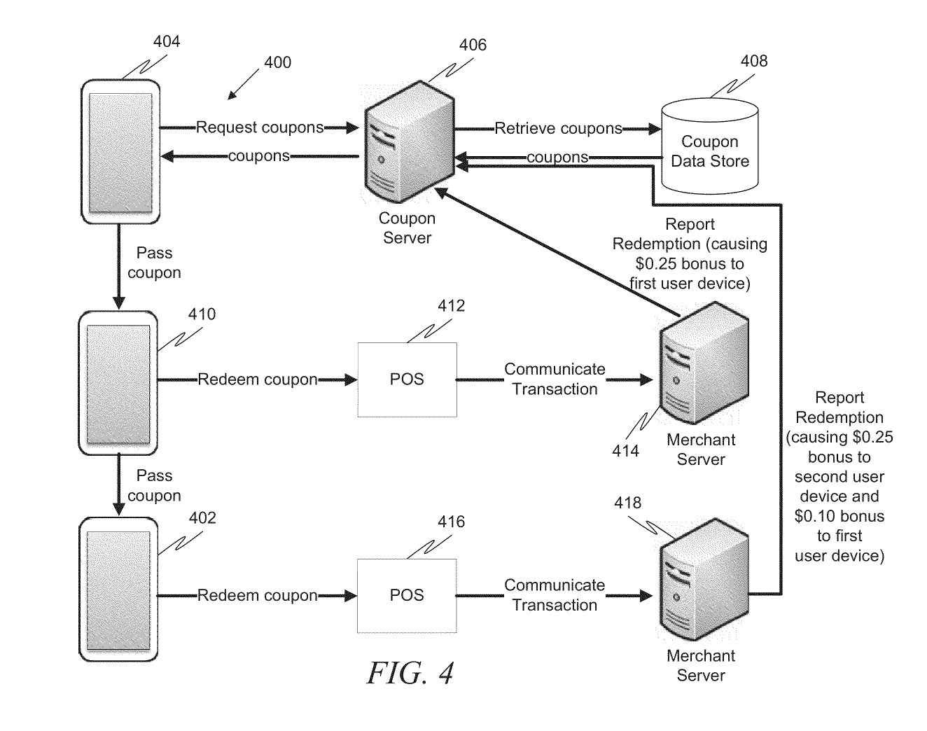

FIG. 4 is a network diagram depicting a networked or network based system, according to another example embodiment, having various components configured for exchanging data over a network. This diagram is similar to that of FIG. 1, in that the system 400 has similarities to the system 100 of FIG. 1, except for the addition of a third user device 402. As in FIG. 1, the first user device 404 passes a coupon received from a coupon server 406 (which obtained the coupon from a coupon data store 408) to the second user device 410. The second user device 410 passes the coupon to the third user device 402. When the second user device 410 redeems the coupon via the merchant Point-of-Service (POS) 412, the first user device 404 receives a $0.25 increase in the value of the coupon. This may be communicated to the first user device 404 by the coupon server 406, which teamed of the redemption from the merchant server 414. This may be communicated to the first user device 404 via, for example, a push mechanism or an email. Of course, it is not strictly necessary for the increase in value to be communicated to the first user device 404. In some embodiments, the merchant server 414 may check the current value of the coupon for a user with the coupon server 406, and thus it is possible that the user may be given a “surprise” increase in the value of the coupon. Depending upon the goals of the promotion, this type of surprise may or may not be useful.

When the third user device 402 redeems the coupon at merchant POS 416, the second user device 410 may receive a $0.25 increase in the value of the coupon, while the first user device 404 receives a $0.10 increase in the value of the coupon. Again, these may be communicated, via the coupon server 406, from a redemption report from the merchant server 418.

It should be noted that while this figure depicts merchant POS 412 and merchant POS 416 as different entities, one of ordinary skill will recognize that they could be the same entity. For example, the second user device 410 and the third user device 402 could redeem the coupon at the same store. The same goes for merchant server 414 and merchant server 418.

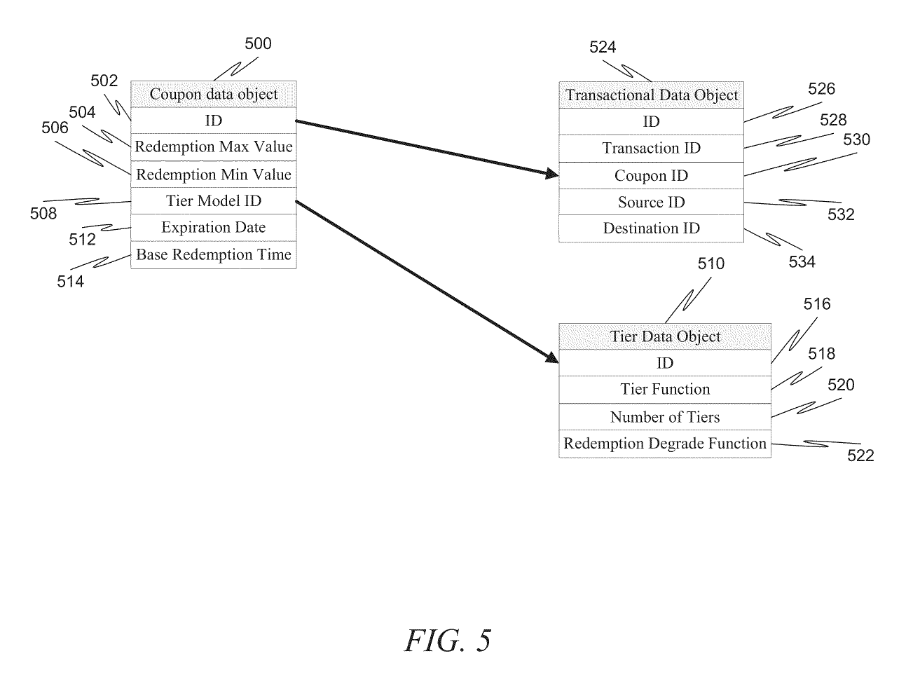

As described earlier, in some example embodiments, the value of the coupon increases based on the redemption of users in lower tiers. The coupon server 406 may maintain a set of tables with information about the dynamic adjustments to the coupon. FIG. 5 is a diagram depicting an example, in accordance with an example embodiment, of coupon related objects maintained by a coupon server. A coupon data object 500 may be unique for each coupon. It may contain an identification 502, redemption maximum value 504 (indicating the maximum potential redemption amount for the coupon), redemption minimum value 506 (indicating the minimum potential redemption amount for the coupon—this may also be the starting redemption amount), tier model identification 508 (indicating a tier data object 510 with information about the compensation rates for each tier), an expiration date 512, and a base redemption time 514. An example redemption maximum value may be 50%, whereas a minimum value may be 10% off. A tier data object 510, unique for each tier compensation program, may contain an identification 516, a description of the tier function 518, a number of tiers 520, and a redemption degrade function 522. The tier function 518 may be applied to the tier level to determine the redemption value. For example, a tier function 518 may be N², logN, N, or N*2, with N being the tier level. Of course, other mathematical functions are possible as well.

Also depicted is a transactional data objection 524. This may be a table passed from a merchant server when a coupon is redeemed, and may thus be unique to each redemption. It may include an identification 526, transaction identification 528, coupon identification 530, source identification 532, and destination identification 534.

In order to facilitate application of the correct additional discount to the correct user, in an example embodiment, a mechanism is provided in order to determine whether a coupon being redeemed is the same coupon as was distributed to a particular user. In other words, a mechanism may be provided to determine whether the coupon redeemed by one user was actually passed to that user from a different user, and to determine who that passing user was in order to provide the additional discount.

In one example embodiment, a tracking mechanism may be embedded into the coupon itself. For example, the coupon may contain a tracking code that is assigned to the user to whom it was initially distributed. Through that mechanism, the coupon server will be able to tell whether a later user in possession of the coupon received the coupon from the earlier user.

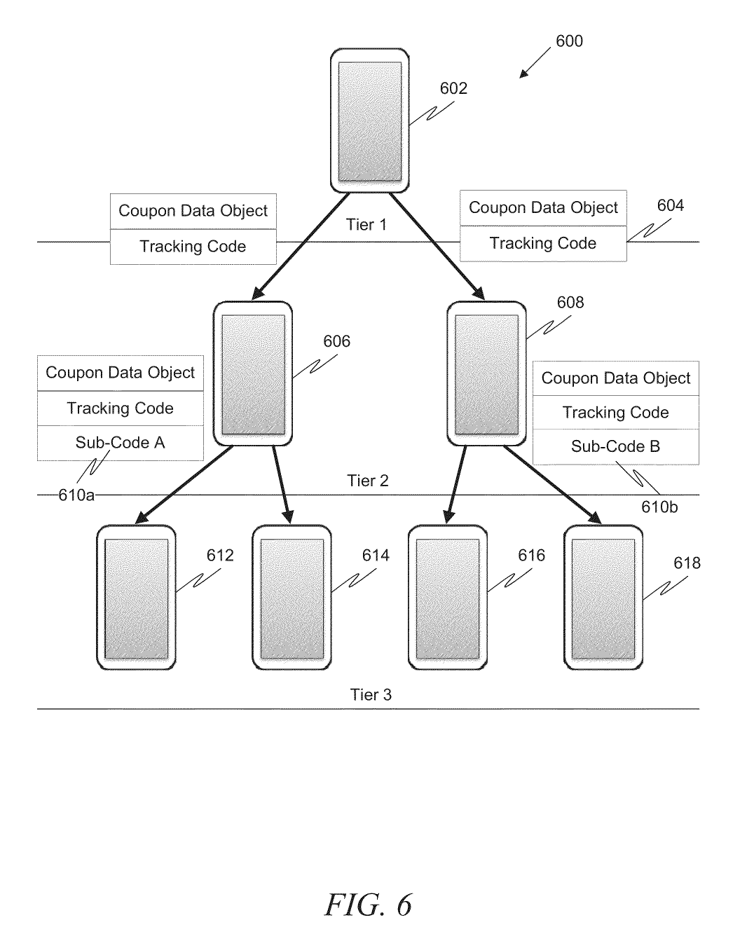

In the case of multiple tiers of users, the coupon may be designed to generate a sub-code each time it is passed. The sub-code may then be useful in tracking whether a user in a middle tier passes the coupon to a user in a lower tier. FIG. 6 is a diagram illustrating a system 600, in accordance with an example embodiment, of tracking electronic coupons. Here, an electronic coupon distributed to a first user 602 may contain a tracking code 604. When the first user 602 passes the coupon to another user (for example, user 606 or 608), additional sub-codes 610a, 610b are generated and appended to the coupon. These sub-codes may be different for the different receiving users 606, 608, as depicted as sub-code A 610a or sub-code B 610b. When these additional users 606, 608 pass the coupon to further users, such as users 612, 614, 616 and 618, additional sub-codes can be generated and appended.

The tracking codes and sub-codes may be unique values for each user, allowing the system to track the lineage of the coupon, and thus enabling the system to award the correct discount to the correct user. Of course, this is merely an example of a mechanism to track electronic coupons, and other systems may be utilized to accomplish the same goal.

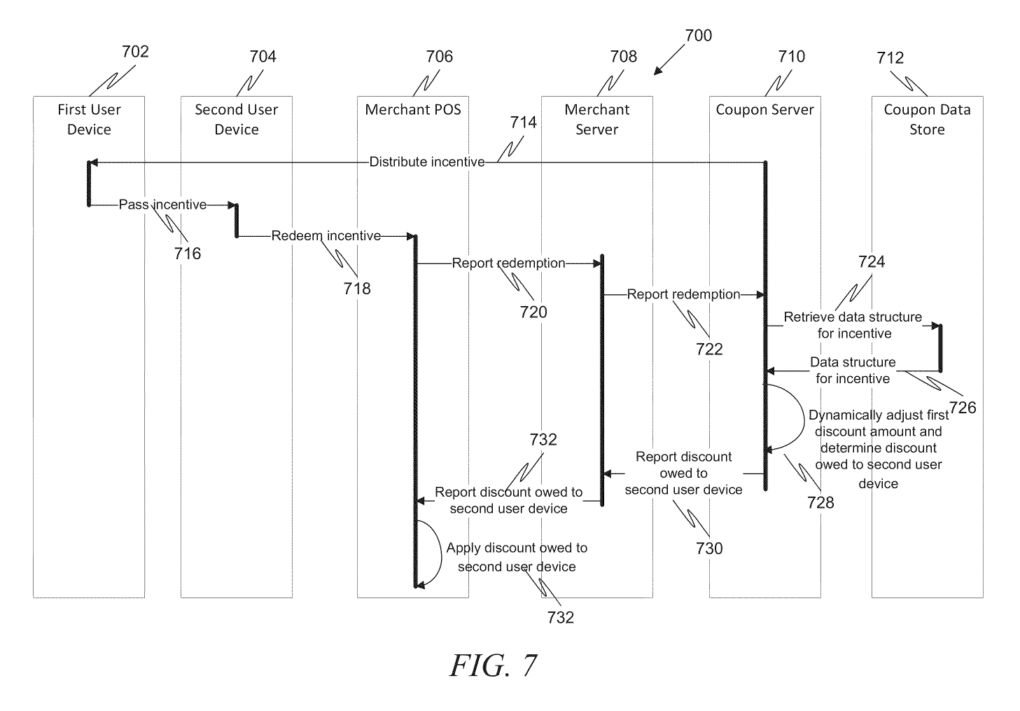

FIG. 7 is an interaction diagram illustrating a method 700, in accordance with an example embodiment, of validating an electronic incentive provided to users. In this method 700, there are a number of components, including a first user device 702, a second user device 704, a merchant point of sale terminal 706, a merchant server 708, a coupon server 710, and a coupon data store 712. At 714, the coupon server 710 distributes an electronic incentive to the first user device 702. This electronic incentive has a first discount amount. At some point, the first user device 702, at 716, passes the electronic incentive to the second user device 704. At 718, the second user device 704 attempts to redeem the electronic incentive at the merchant point of sale terminal 706. This is communicated to the merchant server 708 at 720, and then an indication of this redemption is sent to the coupon server 710 at 722. At 724, the coupon server 710 retrieves a data structure corresponding to the redeemed electronic incentive from the coupon data store 712, which is returned at 726. The coupon server 710 then dynamically adjusts the first discount amount, for the first user device, based on the retrieved data structure, and determines the discount amount owed to the second user device, at 728. At 730, the coupon server 710 communicates the discount amount owed to the second user device to the merchant server 708, which at 732 can communicate this to the merchant point of sale terminal 706 to apply the discount amount at 732.

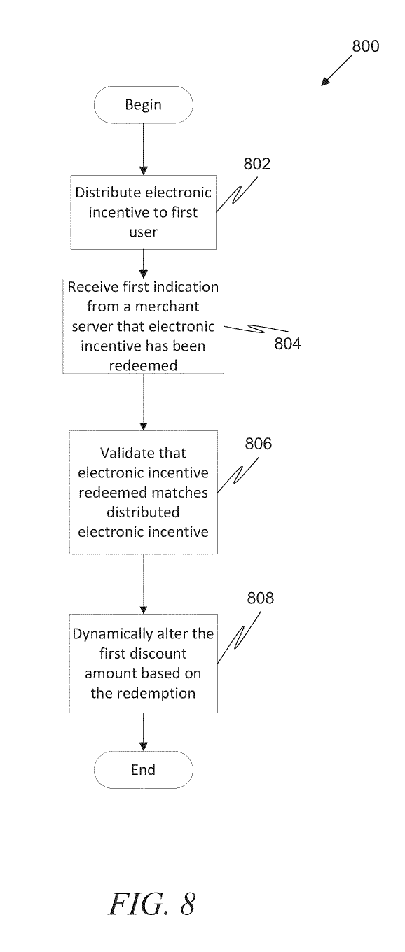

FIG. 8 is a flow diagram illustrating a method 800, in accordance with an example embodiment, of validating an electronic incentive provided to users. At 802, an electronic incentive is distributed to a first user. The electronic incentive, also known as a coupon, provides a discount to the recipient for an item or service. At 804, a first indication is received from a merchant server that the electronic incentive has been redeemed at a merchant point of sale terminal. At 806, it is validated that the electronic incentive referred to in the first indication is the electronic incentive distributed to the first user. This may be performed, as described earlier, using a tracking code affixed to the electronic incentive. At 808, the first discount amount is dynamically altered into a second discount amount different than the first discount amount, on that a redemption of the electronic incentive by the first user provides a discount equal to the second discount amount.

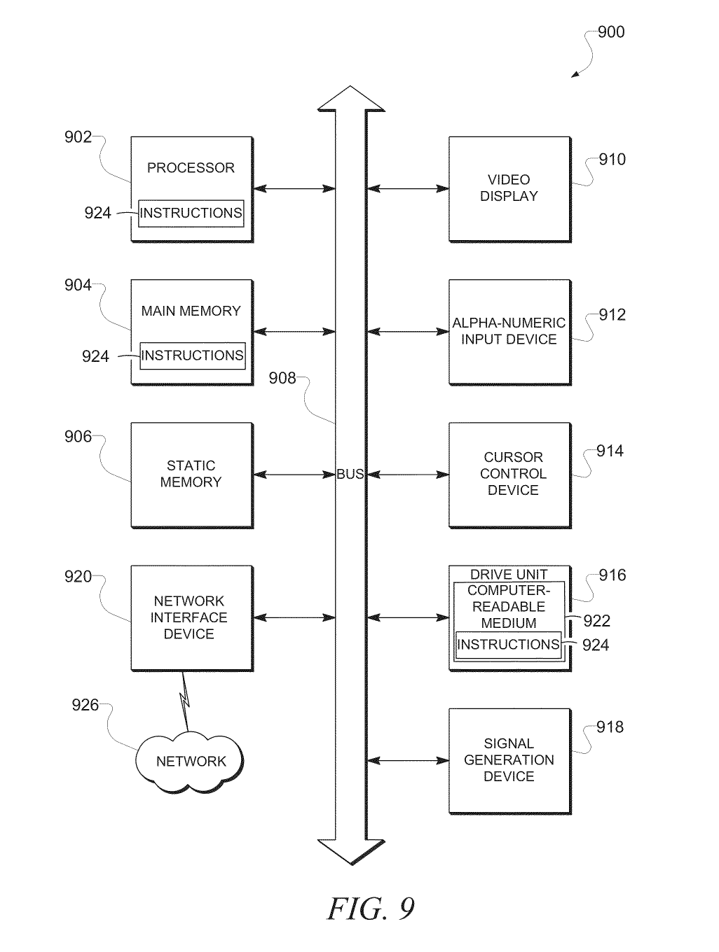

FIG. 9 shows a diagrammatic representation of a machine in the example form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a cursor control device 914 (e.g., a mouse), a disk drive unit 916, a signal generation device 918 (e.g., a speaker), and a network interface device 920.

The disk drive unit 916 includes a machine-readable medium 922 on which is stored one or more sets of instructions (e.g., software 924) embodying any one or more of the methodologies or functions described herein. The software 924 may also reside, completely or at least partially, within the main memory 904 and/or within the processor 902 during execution thereof by the computer system 900, with the main memory 904 and the processor 902 also constituting machine-readable media. The software 924 may further be transmitted or received over a network 926 via the network interface device 920.

While the machine-readable medium 922 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein. The term “machine-readable medium” shall accordingly be taken to include, but not be limited to, solid-state memories, optical and magnetic media, and carrier wave signals.

Although the inventive concepts have been described with reference to specific example embodiments, it will be evident that various modifications and changes may be made to these embodiments without departing from the broader spirit and scope of the inventive concepts. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than features of a single disclosed embodiment. Thus the following claims are hereby incorporated into the Detailed Description, with each claim standing on its own as a separate embodiment.

1. A method of validating an electronic incentive provided to users, the method comprising:
distributing an electronic incentive to a first user, the electronic incentive providing a first discount amount for an item or service;
receiving, from a merchant server, a first indication that the electronic incentive has been redeemed at a merchant point of sale terminal;
validating that the electronic incentive referred to in the first indication is the electronic incentive distributed to the first user; and
dynamically altering the first discount amount into a second discount amount different than the first discount amount, so that a redemption of the electronic incentive by the first user provides a discount equal to the second discount amount.

2. The method of claim 1, wherein the electronic incentive was electronically passed from the first user to the second user.

3. The method of claim 1, wherein the electronic incentive was electronically passed from the first user to the second user via near field communication (NFC).

4. The method of claim 1, wherein the electronic incentive was electronically passed from the first user to the second user via an application server detecting that the first user and the second user are in proximity to each other and detecting that the first user performs a user action indicating a desire to transfer the electronic incentive to the second user.

5. The method of claim 4, wherein the application server detects locations of the first user and the second user by receiving global positioning system (GPS) information from a first electronic device operated by the first user and a second electronic device operated by the second user.

6. The method of claim 4, wherein the user action is a bumping motion.

7. The method of claim 1, wherein the electronic incentive was electronically passed from the first user to the second user via a local wireless networking standard.

8. The method of claim 1, wherein the electronic incentive was electronically passed from the first user to a second user by a second electronic device operated by the second user scanning a first electronic device operated by the first user.

9. The method of claim 8, wherein the scanning includes the second electronic device scanning a bar code displayed on a display of the first electronic device.

10. The method of claim 8, wherein the scanning includes the second electronic device scanning a Quick Response (QR) code displayed on a display of the first electronic device.

11. The method of claim 1, wherein the dynamically altering the first discount amount includes determining an adjustment amount based on a data contained in a data structure corresponding to the electronic incentive.

12. The method of claim 11, wherein the data structure contains an amount to adjust the electronic incentive based upon how many tiers of users lie between the first user and the second user.

13. The method of claim 1, further comprising:
receiving, from a merchant server, a second indication that the electronic incentive has been redeemed at a merchant point of sale terminal;
validating that the electronic incentive referred to in the second indication is the electronic incentive distributed to the first user; and
dynamically altering the second discount amount into a third discount amount different than the second discount amount, so that a redemption of the electronic incentive by the first user provides a discount equal to the third discount amount.

14. The method of claim 1, wherein the dynamically altering the first discount amount is performed when the first user attempts to redeem the electronic incentive.

15. A server comprising:
a processor;
memory;
a coupon module configured to:
receive, from a merchant server, a first indication that an electronic incentive distributed to a first user has been redeemed at a merchant point of sale terminal by a second user, the electronic incentive providing a first discount amount for an item or service;
validate that the electronic incentive refined to in the first indication is the electronic incentive distributed to the first user; and
dynamically alter the first discount amount into a second discount amount different than the first discount amount, so that a redemption of the electronic incentive by the first user provides a discount equal to the second discount amount.

16. The server of claim 15, wherein the dynamically altering of the first discount amount includes determining an adjustment amount based on a data contained in a data structure corresponding to the electronic incentive.

17. The server of claim 16, wherein the data structure contains an amount to adjust the electronic incentive based upon how many tiers of users lie between the first user and the second user.

18. The server of claim 17, wherein the data structure is stored in a coupon data store.

19. A machine-readable non-transitory storage medium having instruction data to cause a machine to execute a method of validating an electronic incentive provided to users, the method comprising:
distributing an electronic incentive to a first user, the electronic incentive providing a first discount amount for an item or service;
receiving, from a merchant server, a first indication that the electronic incentive has been redeemed at a merchant point of sale terminal;
validating that the electronic incentive referred to in the first indication is the electronic incentive distributed to the first user; and
dynamically altering the first discount amount into a second discount amount different than the first discount amount, so that a redemption of the electronic incentive by the first user provides a discount equal to the second discount amount.

20. The machine-readable non-transitory storage medium of claim 19, wherein the distributing is performed using push technology.
